(19) United States
(12) Patent Application Publication
(10) Pub. No.: US 2016/0332475 A1
(43) Pub. Date: Nov. 17, 2016

(54) COIL PRESSING MACHINE WITH HOOKS

(71) Applicant: QINGDAO H. Y. CORPORATION, Qingdao (CN)

(72) Inventor: Yang YU, Qingdao (CN)

(73) Assignee: QINGDAO H. Y. CORPORATION, Qingdao (CN)

(21) Appl. No.: 14/984,775

(22) Filed: Dec. 30, 2015

(30) Foreign Application Priority Data
May 12, 2015 (CN) 201520301461.2

(51) Int. Cl. B42B 5/10; B42B 5/12

(52) U.S. Cl. CPC B42B 5/103; B42B 5/123

(57) ABSTRACT

A coil pressing machine with hooks comprising a machine casing and a machine rack. A push ring device, a power device, a transmission device and a binding device are all set in the inside of the machine casing. The power device is a motor. The transmission device transmits power from the power device to the push ring device and the binding device. The push ring device comprises a push ring transmission mechanism and a push ring mechanism. The push ring transmission mechanism is connected to the transmission device. The coil pressing machine also comprises hooks and hooks below the push ring device that are fixed in front of the machine casing. An orbital groove is also set in the machine casing and the orbital groove and the hooks are slip-connected by threaded twist.

### TECHNICAL FIELD

This invention relates to an office machine for binding papers with a coil, and specifically, it relates to a push ring device and a coil pressing machine. The present application incorporates by reference the subject matter of U.S. patent application Ser. No. 14/524,504.

### BACKGROUND

Known coil pressing machines used in domestic offices take a binding coil from a coil stationary box and attach it to a bundle of papers that have already been punched and then press it manually or electrically. Most foreign machines also adopt this binding method. However, German RENZ has a machine, which can automatically take coils, and press files electrically, but this machine requires special packing of a dual coil, which occupies more space, and has a low efficiency and high cost. Therefore, an automatic ring-picking binding machine suitable for our coil stationary box is needed; however, such a device is not available in the market.

Most of the traditional coil pressing machines have no hooks. Hooks can provide a stable track for the coils. If there are no hooks in the machine, the coil track is not suitable when the coil drops and the binding effect can not acheieve the expected results. Some of the coil pressing machines are produced with hooks. However, the distance between the hooks and the machine casing is permanent and the hooks cannot move. Additionally, the distance between the hooks is unreasonable. Known coil pressing machines have a low efficiency and poor binding quality, and cannot adjust the postion of the coils effectively and conduct binding accurately.

### SUMMARY

The present invention overcomes the above defects and features a push ring device and a coil pressing machine which provides a reasonable setting of the hooks. The specific technical proposal of the present invention is described below.

A coil pressing machine with hooks comprises a machine casing and a machine rack. A push ring device, a power device, a transmission device and a binding device are all set in the inside of the machine casing. The power device is a motor. The transmission device transmits power from the power device to the push ring device and the binding device. The push ring device comprises a push ring transmission mechanism and a push ring mechanism. The push ring transmission mechanism is connected to the transmission device. The coil pressing machine also comprises hooks and a set of hooks below the push ring device which are fixed in the front of the machine casing. Orbital grooves are also set in the machine casing and the orbital grooves and the hooks are slip-connected by a threaded twist.

The hooks can move left and right. The ratio of coils and hooks can be in the range of 2:1 or 3:1.

The threaded twist can adjust the distance between the machine casing and the hooks.

The distance between every hook of the hooks may be in multiples of 25.4 mm. In some implementations, the distance between every hook of the hooks may be in varying multiples.

The coil pressing machine also comprises the hooks and the hooks below the push ring device which are fixed in front of the machine casing. The orbital grooves are also set in the machine casing and the orbital grooves and the hooks are slip-connected by the threaded twist. This kind of coil pressing machine can bind the coils more accurately. The position of hooks is adjustable. This kind of coil pressing machine with a simple structure, provides a low cost and a strong practicality, and can be adjusted to accommodate different size coils.

The hooks of the coil pressing machine are set below the push ring device and fixed in front of the machine casing. The push board pushes the coils falling and the coils slide to the hooks, which are matched closely. In this way, the efficiency of the binding can be improved. The coil pressing machine also has a strong practicality.

The hooks can move left and right. The ratio of coils and hooks can be in the range of 2:1 or 3:1. In some implementations, this ratio may vary. When the coils fall, the falling position has a deviation. Through the adjustment of hooks, the ratio of coils and hooks can be adjusted to in the range of 2:1 or 3:1 to avoid the deviation and make sure the coils can drop into the hooks accurately.

The threaded twist can adjust the distance between the machine casing and the hooks. The distance between the machine casing and the hooks can be adjustable to accommodate the different sizes of coils with a simple structure, thus providing strong practicality.

The distance between every hook of the hooks is in the multiples of 25.4 mm, which is the least common multiple of the gap of coils. The hooks can make the coils permanently situated.

### BRIEF DESCRIPTION OF THE DRAWINGS

FIG. 1 is a structure diagram of a coil pressing machine comprising: a machine casing, a machine rack, a push ring transmission mechanism, a push ring mechanism, hooks, and a threaded twist.

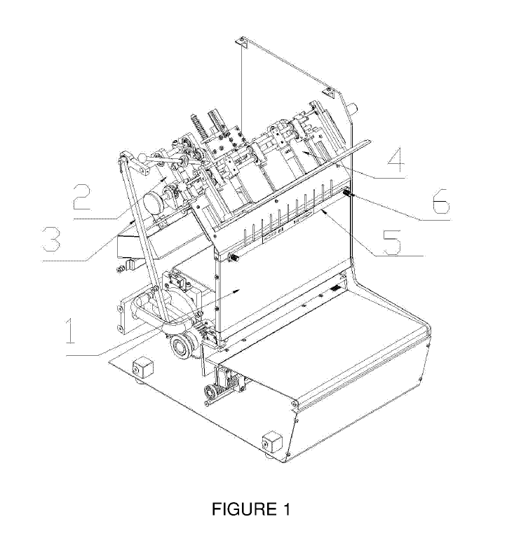

### DETAILED DESCRIPTION OF THE DRAWINGS

### Embodiment One

A coil pressing machine comprises a machine casing 1 and machine rack 2. The coil pressing machine further comprises a push ring device, a power device, a transmission device and a binding device which are all set in the inside of the machine casing 1. The power device is a motor. The transmission device transmits power from the power device to the push ring device and binding device. The push ring device comprises a push ring transmission mechanism 3 and a push ring mechanism 4. The push ring transmission mechanism is connected with the transmission device. The coil pressing machine also comprises hooks 5 and the hooks 5 located below the push ring device are fixed in front of the machine casing 1. The orbital grooves are also set in the machine casing 1 and the orbital grooves and hooks are slip-connected by the threaded twist 6. The hooks 5 can move left and right. The ratio of coils and hooks 5 can be in the range of 2:1 or 3:1. The threaded twist 6 can adjust the distance between machine casing 1 and the hooks 5. The distance between every hook of the hooks may be 25.4 mm.

### Embodiment Two

The difference between the embodiment two and embodiment one is that the distance between every two hooks is two times of 25.4 mm.

The above description is an implementation of this invention, and the protection range of this invention is not limited to the above implementation. All technical proposals which are described above are within the protection range. As for the technicians in this field, any modification or trimmings related to the principle of this invention should be considered within the protection range.

What is claimed is:

1. A coil pressing machine with hooks comprises:
a machine casing;
a machine rack;
a push ring device;
a power device;
a transmission device;
a binding device,
wherein the push ring device, the power device, the transmission device and the binding device are set in the inside of the machine casing,
wherein the power device is a motor,
wherein the transmission device transmits power from the power device to the push ring device and the binding device, and
wherein the push ring device comprises a push ring transmission mechanism and a push ring mechanism, the push ring transmission mechanism is connected to the transmission device,
a plurality of hooks, wherein the hooks below the push ring device are fixed in front of the machine casing; and
an orbital groove set in the machine casing, wherein the orbital groove and the hooks are slip connected.

2. The coil pressing machine with the hooks of claim 1, wherein the hooks move left and right and the ratio of the coils and the hooks are 2:1 or 3:1.

3. The coil pressing machine with the hooks of claim 1,
wherein the coil pressing machine is threaded and further comprises a threaded twist, and
wherein the threaded twist adjusts the distance between the machine casing and the hooks.

4. The coil pressing machine with the hooks of claim 1, wherein the distance between every hook of the hooks is in multiples of 25.4 mm.
